(19) United States
(12) Patent Application Publication
(10) Pub. No.: US 2009/0190776 A1
(43) Pub. Date: Jul. 30, 2009

(54) SYNTHESIZING A MICROPHONE SIGNAL

(76) Inventor: Friedrich Reining, Vienna (AT)

Correspondence Address: HARMAN - BRINKS HOFER CHICAGO;Brinks Hofer Gilson & Lione, P.O. Box 10395, Chicago, IL, 60610, US

(21) Appl. No.: 12/391,038

(22) Filed: Feb. 23, 2009

(30) Foreign Application Priority Data
Nov. 13, 2007 (AT) PCT/AT2007/000512
Nov. 13, 2007 (AT) PCT/AT2007/000513
Nov. 30, 2007 (AT) PCT/AT2007/000542

(51) Int. Cl. H04R 3/00

(52) U.S. Cl. 381/92

(57) ABSTRACT

A method synthesizes a microphone signal from a coincident microphone arrangement through multiple pressure gradient transducers. The pressure gradient transducers have directional characteristics that include an omni portion and a figure-eight portion. The direction of maximum sensitivity of the transducers lies within in a main direction. The method synthesizes a signal by forming a difference signal and a summed signal from the output of the two pressure gradient transducers. The difference and summed signals are converted into the frequency domain before the signals are spectrally subtracted. The method designates a representative phase to the magnitude of the spectrally subtracted signal. The phase corresponds to the phase of the summed signal. The signal and phase is then converted into the time domain.

### PRIORITY CLAIM

This application claims the benefit of priority from PCT/AT2007/000542, filed Nov. 30, 2007, PCT/AT2007/000512, filed Nov. 13, 2007, and PCT/AT2007/000513, filed Nov. 13, 2007, each of which are incorporated by reference.

### BACKGROUND OF THE INVENTION

1. Technical Field

The disclosure relates to synthesizing a microphone signal from a coincident microphone arrangement.

2. Related Art

In environments filled with background noise, such as vehicles, cockpits, etc., it is challenging to record high quality signals. In many circumstances, the signal-to-noise ratio (SNR) is too low to achieve reliable communication. Some systems attempt to mitigate these conditions by recording or estimating background noise. The recording or estimate is processed with a received signal in the time domain, so that a useful signal remains. An alternative utilizes several microphones to form a directional characteristic. The directional characteristic is processed to ensure only a receiving (useful) sound is recorded. Unfortunately, the system may not effectively minimize interference and may generate background scatter, artifacts, time delays, that reduce the intelligibility.

### SUMMARY

A method synthesizes a microphone signal from a coincident microphone arrangement through multiple pressure gradient transducers. The pressure gradient transducers have directional characteristics that include an omni portion and a figure-eight portion. The direction of maximum sensitivity of the transducers lies within in a main direction. The method synthesizes a signal by forming a difference signal and a summed signal from the output of the two pressure gradient transducers. The difference and summed signals are converted into the frequency domain before the signals are spectrally subtracted. The method designates a representative phase to the magnitude of the spectrally subtracted signal. The phase corresponds to the phase of the summed signal. The signal and phase is then converted into the time domain.

Other systems, methods, features, and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is shows a microphone array.

FIG. 2 shows the directional characteristic of the individual transducers of FIG. 1.

FIG. 3 is a microphone arrangement.

FIG. 4 shows the directional characteristic of the transducers of FIG. 3.

FIG. 5 shows an alternate microphone arrangement.

FIG. 6 shows the pressure gradient transducers within a common housing.

FIG. 7 shows an arrangement at a boundary.

FIG. 8 shows transducers embedded in a boundary.

FIG. 9 shows transducers embedded in a boundary.

FIG. 10 shows a transducer orientation relative to the boundary.

FIG. 11 shows a gradient transducer with sound inlet openings on opposite sides of the transducer housing.

FIG. 12 shows a gradient transducer with sound inlet openings on the same side of the transducer housing.

FIG. 13 shows a block diagram of a signal processing unit.

FIG. 14 shows a spectral subtraction unit in detail.

FIG. 15 shows directional characteristics of three transducers and potential sound directions.

FIG. 16 shows built-up directional characteristics of the signals of FIG. 13.

FIG. 17 shows a microphone arrangement, directional characteristics, and intermediate signals.

FIG. 18 shows a microphone arrangement, directional characteristics, and intermediate signals.

FIG. 19 shows a microphone arrangement, directional characteristics, and intermediate signals.

FIG. 20 is a schematic concept of coincidence.

### DETAILED DESCRIPTION OF THE PREFERRED EMBODIMENTS

A noise suppression system includes two (or more) pressure gradient transducers. A difference signal and a sum signal are formed from the output. The difference signal and the sum signal are transformed into a frequency domain and subtracted from each other through a spectral subtractor, independent of their phases. The difference signal is assigned phase of the signal before it transformed into the time domain.

The noise suppression system microphone arrangement includes pressure gradient transducers. The projections in the main direction of the pressure gradient transducers are inclined relative to each other in a boundary. The acoustic centers of the pressure gradient transducers lie within an imaginary sphere having a radius corresponding to about double the largest dimension of the diaphragm of the pressure gradient transducer. The position of the acoustic center ensures the coincident position of the transducers.

In an alternate system, the acoustic centers of the pressure gradient transducers lie within an imaginary sphere having radius corresponding to the largest dimension of the diaphragm of a transducer. Sound intelligibility may improve by moving the sound inlet openings close together. When this arrangement is positioned on a boundary, shadowing effects may be eliminated or reduced.

An alternative microphone arrangement may include two or more pressure gradient transducers, each with a diaphragm and transducer housing. Each pressure gradient transducer includes a first sound inlet opening that leads to the front of the diaphragm and a second sound inlet opening that leads to the back of the diaphragm. The directional characteristic of each pressure gradient transducer includes an omni portion and a figure-eight portion. The first and second sound inlet openings in the pressure gradient transducers are arranged on a common side. The front of the transducer housing and the front sides of the pressure gradient transducers may lie substantially in a plane. The projections of the main directions of the pressure gradient transducers are inclined relative to each other in this plane. The acoustic centers of the pressure gradient transducers may be within an imaginary sphere having a radius corresponding to about double of the maximum dimension of the diaphragm of the pressure gradient transducer.

A microphone signal may be synthesized through a linear filtering that adapts different frequency responses of the individual gradient transducers to each other. A subtraction signal (or difference signal) and a sum signal may be formed from the linearly filtered gradient signals. By transformation of these signals into the frequency domain, for example, by an FFT device (fast Fourier transformation) and a subsequent spectral subtraction (e.g. through a subtractor), uniform bundling over the entire frequency range may occur. The coincident arrangement may suppress or minimize.

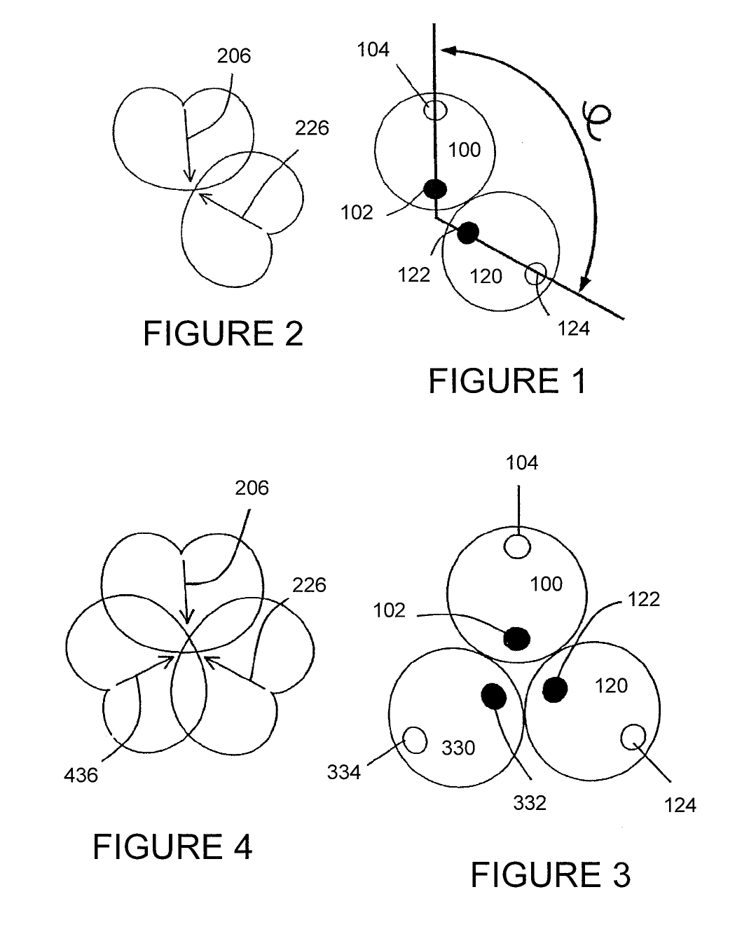

FIG. 1 is a microphone arrangement comprising two pressure gradient transducers 100, 120. The directional characteristic of each pressure gradient transducer may include an omni portion and a figure-eight portion (e.g., bi-directional) directional characteristic may be represented as P(θ)=k+(1−k)×cos(θ), in which k denotes the angle-independent omni portion and (1−k)×cos(θ) denotes the angle-dependent figure-eight portion. The directional distribution of the individual transducer of FIG. 1 (shown in FIG. 2) involves a gradient transducer with a cardioid characteristic. In alternative arrangements, other characteristics are generated. The characteristics may be a combination of a sphere and figure-eight forms and may include, hypercardioids, supercardioids, etc.

The gradient transducers 100, 120 in FIG. 1 lie in a plane, in which their main directions—the directions of maximum sensitivity—are inclined relative to each other by the azimuthally angle φ. The main directions 206, 226 of the transducers are inclined with respect to each other by angle φ. In an alternative system, any type of gradient transducer that converts one form of energy to another may be used. The system may include a flat transducer or boundary microphone, in which the two sound inlet openings lie on the same side surface, e.g., the boundary.

In FIG. 3, three gradient transducers 100, 120, 330 are arranged in a plane and with main directions 206, 226, 436 inclined relative to each other by an angle of about 120°. The main directions—the directions of maximum sensitivity—point to a common center area of the arrangement (FIG. 4). In FIG. 3 two sound inlet openings of the gradient transducer are arranged on the same side of the transducer housing, so that all openings lie on a substantially flat surface. The front sound inlet openings 102, 122, 332 lie in a center area that may be on an imaginary inner circle around the center. The rear sound inlet openings 104, 124, 334 lie on an outer circle that may be concentric to the inner circle. The individual transducers 100, 120, 330 may be positioned as close as possible to each other to improve coincidence.

In some multiple gradient transducers arrangement, the acoustic centers of the pressure gradient transducers may lie within an imaginary sphere having a radius corresponding to about double the maximum dimension of the diaphragm of one of the pressure gradient transducers. When three transducers are used, the arrangements may render an optimized configuration. Since the acoustic center in boundary microphones may lie in an area of the first sound inlet opening, the coincidence condition may be transferred to the position of the first sound inlet openings.

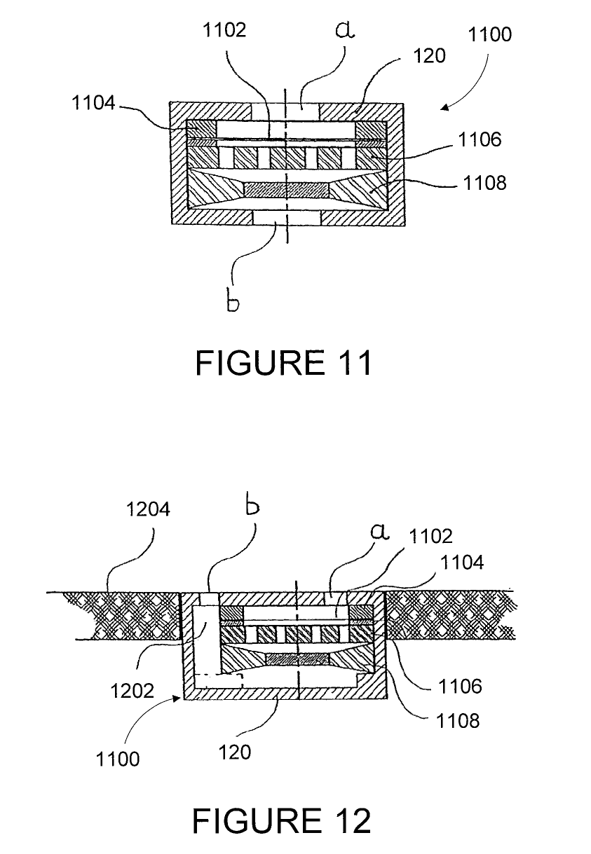

FIG. 11 and FIG. 12 show the difference between a “normal” gradient transducer and a “flat” gradient transducer. In FIG. 11, a sound inlet opening “a” is positioned on the front of the transducer housing 1100 and a second sound inlet opening “b” is situated on the opposite back side of the transducer housing 1100. The front sound inlet opening “a” is connected to the front of diaphragm 1102, which is stretched on a diaphragm ring 1104, and the back sound inlet opening “b” is connected to the back of diaphragm 1102. The arrows show the path sound waves travel to the front or back of diaphragm 1102. An acoustic friction element 1108 may be positioned behind electrode 1106. The acoustic friction element 1108 may comprise constriction, a non-woven element, foam, or other materials that impede flow.

In the flat gradient transducer from FIG. 12, (e.g., like a boundary microphone) sound inlet openings a, b are provided on the front of the transducer housing 1100, in which one leads to the front of diaphragm 1102 and the other leads to the back of diaphragm 1102 through a sound channel 1202. The transducer may be incorporated in a boundary 1204, for example, a console in a vehicle, for example. The acoustic friction element 1108, may comprise non-woven materials, foams, constrictions, perforated plates, etc., that may be arranged near or adjacent to diaphragm 1102. By arranging sound inlet openings a, b on one side of the housing or capsule, a directional characteristic asymmetric to the diaphragm axis may be generated (e.g., a cardioid, hypercardioid, etc.). The housing or capsule may include characteristics described in EP 1 351 549 A2 and U.S. Pat. No. 6,885,751 A, which are incorporated by reference. In some capsules, the front of the diaphragm comprises a side that may be reached relatively unhampered by sound. The back of the diaphragm may be reached after passing through an acoustically phase-rotating element by the sound. In these arrangements, the sound path to the front may be shorter than the sound path to the back.

In FIG. 1, sound inlet openings 102 and 122 that lead to the front of the corresponding diaphragm may lie close together. The sound inlet openings 104, 124 that lead to the back of the diaphragm may lie on the periphery of the arrangement. The point of intersection of the lengthened connection lines that join the front sound inlet opening 102 and 122 to the rear sound inlet opening 104 and 124 is viewed from the center of the microphone arrangement. The front sound inlet openings 102 and 124 of the two transducers 100 and 120, or mouthpieces, are positioned in the center area of the arrangement. The coincidence of the transducers may be increased by this arrangement.

The coincidence may occur due to the acoustic centers of the gradient transducers 100, 120, and 130 that may be positioned close together. In some arrangements the center may occur at a common point. The acoustic center of a reciprocal transducer may be the point from which onmi waves seem to be diverging when the transducer is acting as a sound source. “A note on the concept of acoustic center”, by Jacobsen, Finn; Barrera Figueroa, Salvador; Rasmussen, Knud; Acoustical Society of America Journal, Volume 115, Issue 4, pp. 1468-1473 (2004), which is incorporated by reference, examines ways of determining the acoustic center of a source, including methods based on deviations from the inverse distance law and methods based on the phase response. “The acoustic center of laboratory standard microphones” by Salvador Barrera-Figueroa and Knud Rasmussen; The Journal of the Acoustical Society of America, Volume 120, Issue 5, pp. 2668-2675 (2006), which is also incorporated by reference, describes how acoustic centers may be identified.

The acoustic center may also be determined by measuring spherical wave fronts during sinusoidal excitation of the acoustic transducer. The measurement may occur at a selected frequency in a selected direction and at a certain distance from the transducer in a small spatial area. The area may be an observation point. Analysis of the spherical wave fronts may identify the center of the omni wave or the acoustic center.

For a reciprocal transducer, such as a condenser microphone, the transducer may be utilized as a sound emitter or sound receiver. The acoustic center may be identified by:

$$\begin{matrix}p ( r ) = j \frac{ρ * f}{2 * {r}_{t}} {M}_{f} * i * {e}^{- γ * {r}_{t}} \\ {r}_{t} … Acoustic center \\ ρ … Density of air \\ f … Frequency \\ {M}_{f} … Microphone sensitivity \\ i ... Current \\ γ ... Complex wave propagation coefficient & ( 1 )\end{matrix}$$

In a pressure receiver exclusively, the center may comprise average frequencies (in the range of about 1 kHz), that may deviate at high frequencies. The acoustic center of a pressure receiver may occur in a small area. To determine the acoustic center of gradient transducers, a different approach is used, since formula (I) does not consider the near-field-specific dependences. The location of an acoustic center may be identified by locating the point in which a transducer must be rotated to observe the same phase of the wave front at the observation point.

In a gradient transducer, an acoustic center may be identified through a rotational symmetry. The acoustic center may be positioned on a line normal to the diaphragm plane. The center position on the line may be determined by two measurements: at a point most favorably from the main direction, about 0°, and at point of about 180°. In addition to the phase responses of these measurements, for an average estimate of the acoustic center the rotation point around which the transducer is rotated between measurements, may be changed in the time domain. The adjustment may ensure that the impulse responses are maximally congruent (e.g., the maximum correlation between the two impulse responses lies in the center).

In some microphone arrangements, in which the two sound inlet openings are situated on a boundary, the acoustic center is not the diaphragm center. The acoustic center may lie closest to the sound inlet opening that leads to the front of the diaphragm. This forms the shortest connection between the boundary and the diaphragm. In other arrangements, the acoustic center may lie outside of the transducer or capsule.

The coincidence criterion may require, that the acoustic centers 2006, 2026, 2036 of the pressure gradient capsules 100, 120, 330 lie within an imaginary sphere O, having radius R that is double (or about double) of the largest dimension D of the diaphragm of a transducer. In alternative systems, the acoustic centers of the pressure gradient transducers may lie within an imaginary sphere whose radius corresponds to the largest dimension of the diaphragm of a transducer. By increasing the coincidence through movement of the sound inlet openings, performance may improve.

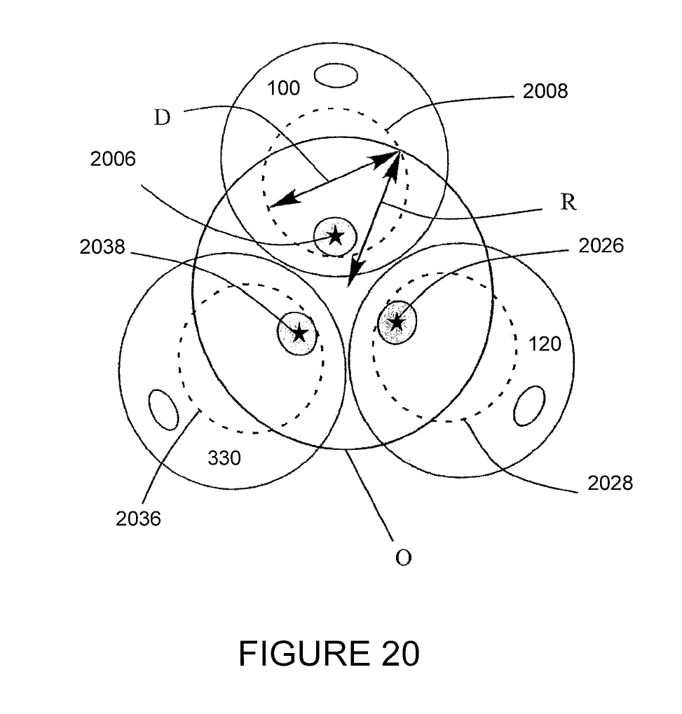

To ensure a coincidence condition, the acoustic centers 2006, 2026, 2036 of the pressure gradient capsules 100, 120, 330 of FIG. 20 lie within an imaginary sphere O, having radius R is equal to (or about equal to) the largest dimension D of the diaphragm of a transducer. The size and position of the diaphragms 2008, 2028, 2036, are indicated in FIG. 20 by dashed lines. In an alternative, this coincidence condition may be established in that the first sound inlet openings 102, 122, 332 lie within an imaginary sphere whose radius is equal to (or alternatively smaller than) the largest dimension of the diaphragm in a pressure gradient transducer. Since the size of the diaphragm determines the noise distance, and therefore represents a direct criterion for the acoustic geometry, use of the maximum diaphragm dimension (for example, the diameter of a round diaphragm, or a side length in a triangular or rectangular diaphragm) may determine the coincidence condition. In some systems diaphragms 2008, 2028, and 2036 may not have the same dimensions. In these systems, the largest diaphragm may be used to determine the preferred criterion.

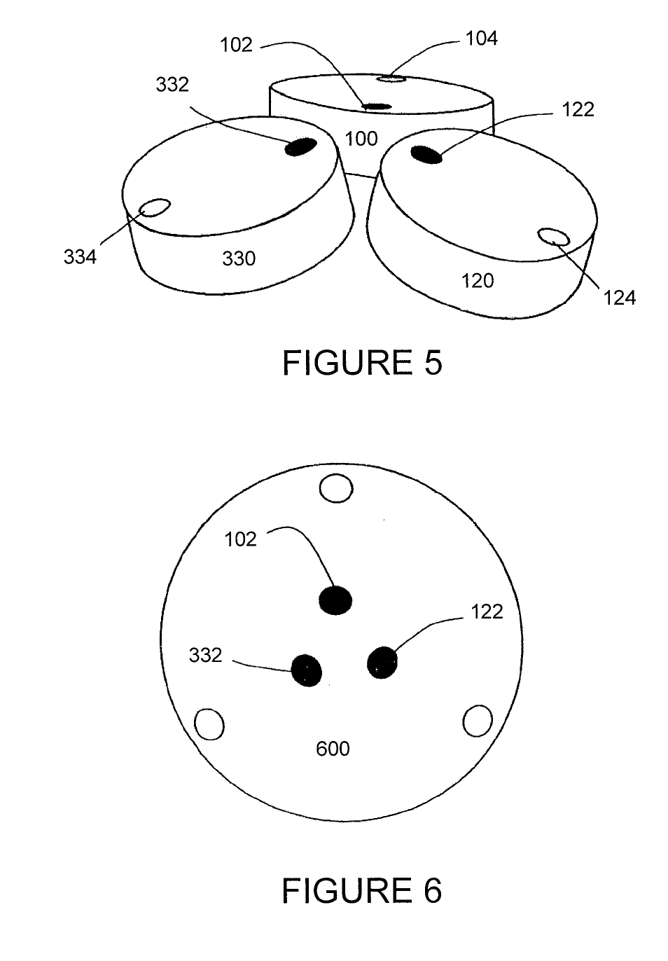

FIG. 5 shows an alternative microphone arrangement, in which the gradient transducers are not arranged in a plane, but on an imaginary omni surface. The sound inlet openings of the microphone arrangement may be arranged on a curved boundary, like a console of a vehicle, for example.

In a curvature arrangement, on the one hand, the distance to the center is reduced (which is desirable, because the acoustic centers may lie closer together), and the mouthpiece openings may be somewhat shaded. A curved arrangement may alter the directional characteristic of the individual transducers to the extent that a figure-eight portion of the signal becomes smaller (from a hypercardioid, then a cardioid). To minimize the adverse effect of shadowing, the curvature may be limited (e.g., not to exceed 60°). The pressure gradient transducers may be positioned on the outer surface of an imaginary cone whose surface line encloses with the cone axis an angle of at least 30°.

FIG. 6 shows another alternative in which the pressure gradient transducers 100, 120, 330 are arranged within a common housing 600, in which the diaphragms, electrodes and mounts of the individual transducers are separated from each other by immediate walls. The first sound inlet openings 102, 122, 332 that lead to the front of the diaphragm and the second sound inlet openings 104, 124, 334 that lead to the back of the diaphragm may no longer be seen from an outside view. The surface of the common housing 600, in which the sound inlet openings are arranged, may be a plane (referring to exemplary arrangement of to FIG. 1) or a curved surface (referring to the exemplary arrangement of to FIG. 5). The boundary may comprise a plate, console, wall, cladding, etc.

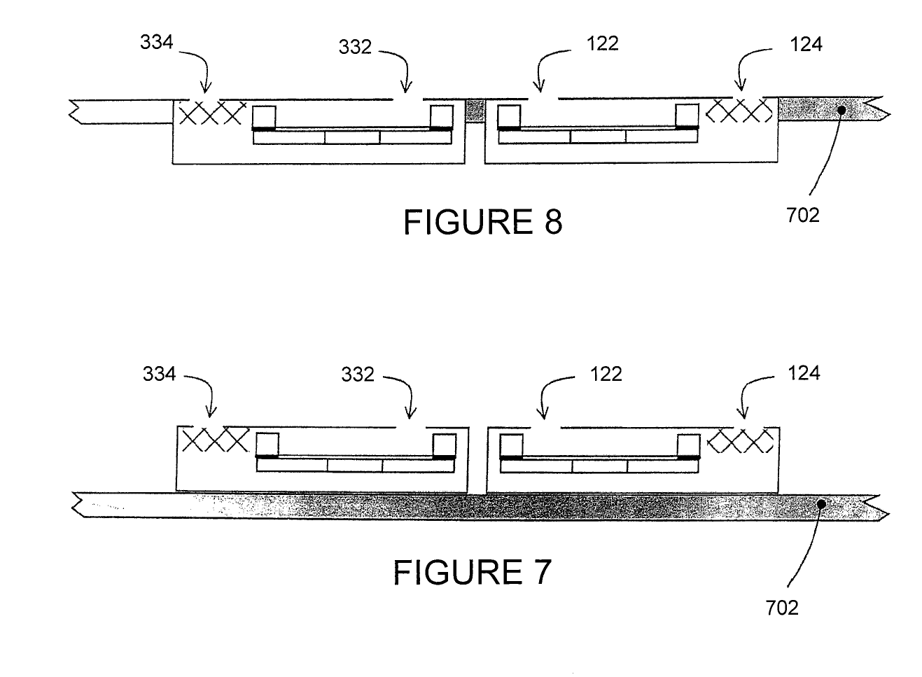

Boundary arrangements are shown in FIGS. 7 and 8. In FIG. 7, the transducers are positioned on boundary 702. In FIG. 8, the transducers are positioned on substantially flush in boundary 700.

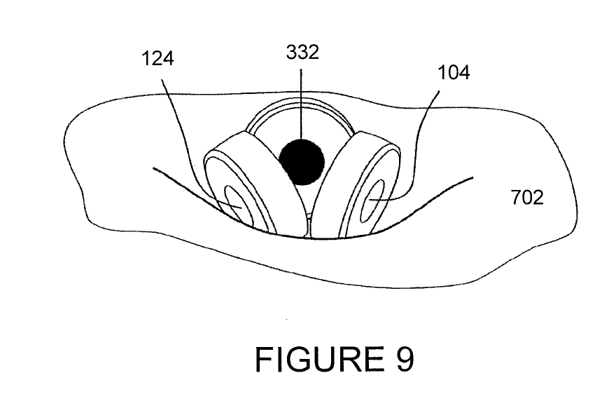

FIG. 9 is an alternative arrangement that includes transducers without a one-side sound inlet microphone. In each of the pressure gradient transducers 100, 120, 330, the first sound inlet openings 102, 122, 332 are arranged on the front of the transducer housing and the second sound inlet openings 104, 124, 334 are arranged on the back of the transducer housing. The first sound inlet openings that lead to the front of the diaphragm face each other. They lie within an imaginary sphere whose radius is equal to (or about equal to) the largest dimension of the diaphragm of a pressure gradient transducer. The main directions of the three gradient transducers point to a common center area of the microphone arrangement. The projections of the main directions, in a plane in which the first sound inlet openings 102, 122, 332 or their centers lie, referred to as the base plane, enclose an angle of about 120° with each other.

In FIG. 9, the gradient transducers are embedded within a boundary 702. In this arrangement the sound inlet openings are not covered by the boundary 702.

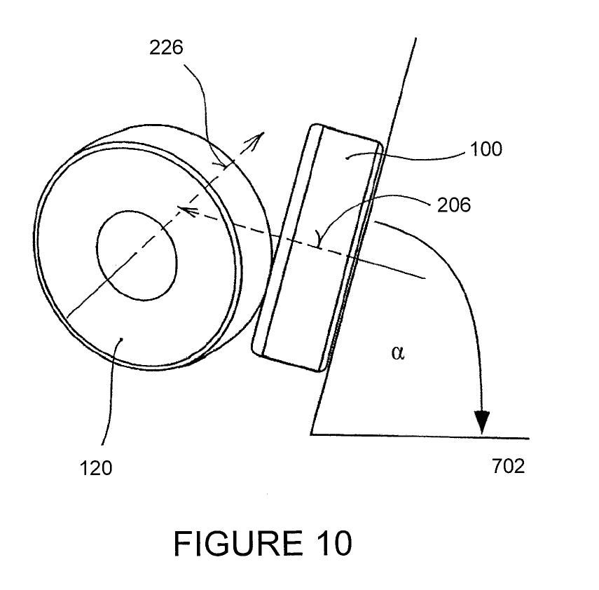

FIG. 10 is an exemplary of two transducers 100, 120 arrangement and an angle of inclination α to a boundary (viewed for an area of the boundary that is not defined by local recesses for the transducer). In FIG. 10, a lies between about 30° and about 90°. At about 0°, the main directions 206, 226 are parallel (or substantially parallel) to each other. In a parallel arrangement, no differentiated information about the sound field may be obtained. In one exemplary arrangement like FIG. 10, the angle between the corresponding main directions and the boundary 702 in its overall trend may lie at an angle between about 0° and about 60°.

In an alternative exemplary arrangement, the gradient transducers may be positioned on an outer surface of an imaginary cone. The acoustic centers may be positioned next to each other so that the front sound inlet openings face each other. This may occur in a curved arrangement, when the sound inlet openings are arranged on a curved boundary, like a console of a vehicle, for example.

Like the arrangement in which the transducers are arranged in a plane, the main directions of the transducers are inclined with respect to each other by an azimuthal angle φ, (e.g., they are not only inclined relative to each other in the plane of the cone axis, but the projections of the main directions are also inclined relative to each other in a plane normal to the cone axis).

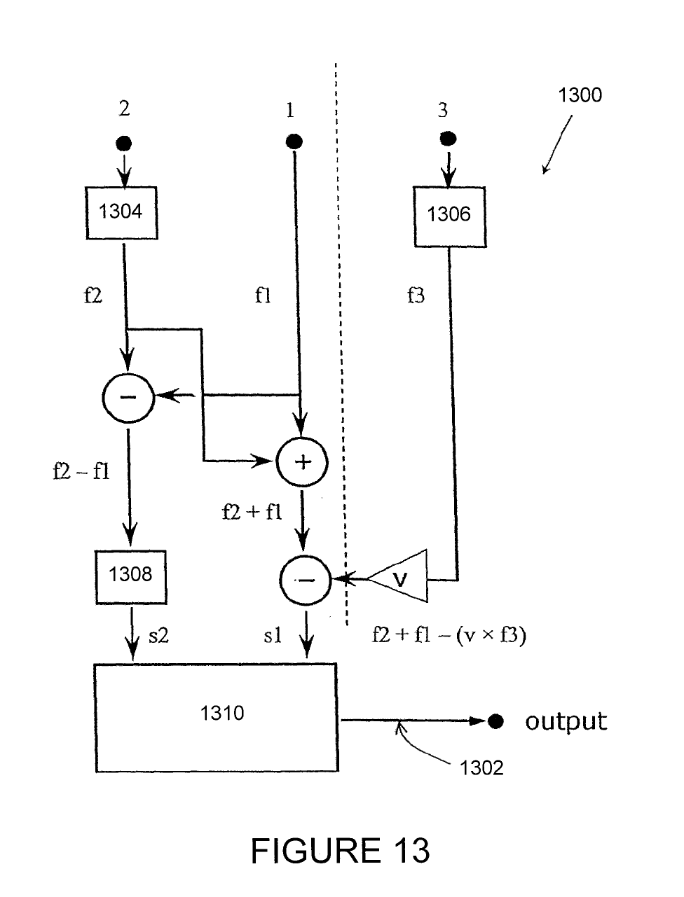

FIG. 13 shows a block diagram that may be implemented or stored on a computer readable media that may be executed by a processor. In the exemplary arrangement when a system comprises two transducers, the signal processing may occur according to the left portion of the block diagram (to the left of the dashed separation line). When a system includes a third transducer (or more), the block diagram is supplemented by the signal path to the right of the separation line (with additional logic to process the outputs that are greater than three).

FIG. 13 is a block diagram between outputs 206, 226, 436 of individual transducers 100, 120, 330 and output 1302 of the signal processing unit 1300. The transducer signals are digitized with A/D converters (not shown). Subsequently, the frequency responses of the output of the transducers are adjusted to compensate for the manufacturing tolerances or other differences. This occurs by linear filters 1304, 1306, which adjust the frequency responses of transducers 120 and 330 to that of transducer 100. The filter coefficients of the linear filters 1304, 1306 are determined from the impulse responses of the participating gradient transducers, with the impulse responses are measured from an angle of about 0°, in the main direction. An impulse response is the output signal of a transducer when it is exposed to a narrowly limited acoustic pulse in time. When determining filter coefficients, the impulse responses of transducers 120 and 330 are compared with that of transducer 100. In FIG. 13 the impulse responses of all gradient transducers 100, 120, 330, after passing through linear filters, may have the same (or substantially the same) frequency response. This arrangement serves to compensate for deviations in the properties of the individual transducers relative to each other.

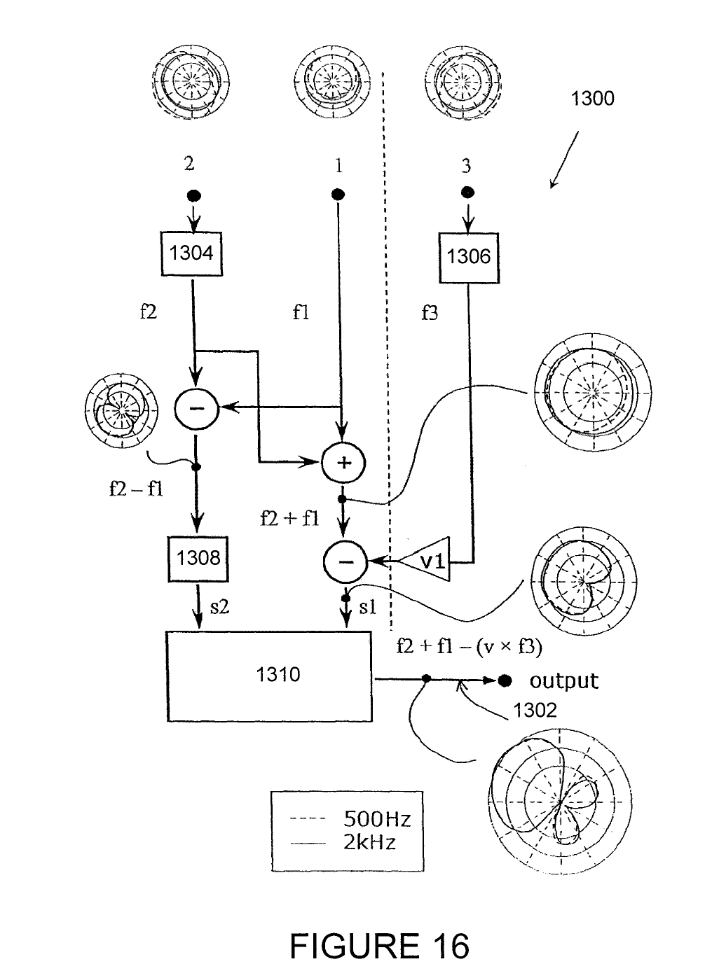

In FIG. 16, a sum signal f1+f2 and a difference signal f1−f2 are formed from the filtered transducer signals f1 and f2 of transducers 100 and 120. The sum signal is dependent on the orientation of the individual gradient transducers or the angle of their main directions and contains a more or less large omni portion.

At least one of the two signals f1+f2 or f2−f1 is processed in another linear filter 1308. This filtering adjusts the two signals to each other, so that the subtraction signal f2−f1 and the sum signal f1+f2, which have an omni portion, undergo maximal rejection when overlapped. The subtraction signal f2−f1, which has a “figure-eight” directional characteristic, is expanded or compressed in a frequency-dependent function in filter 1308, to the extent that its maximal rejection in the resulting signal occurs during its subtraction from the sum signal. The adjustment in filter 1308 occurs for each frequency, and each frequency range, separately.

Determining the filter coefficients of filter 1308 may also occur through the impulse responses of the individual transducers. Filtering of the subtraction signal f2−f1 renders signal s2 and the (optionally filtered) summation signal f1+f2 gives the signal s1 in the exemplary two transducers arrangements 110, 120 (the optional portion of the signal processing unit 1300, shown to the right of the dashed separation line, may not be present in a two transducer arrangement).

In a three transducer 100, 120, 130 arrangement, the third transducer signal may be processed (to the right of the separation line in FIG. 13). The signal f3, adjusted to transducer 100 by the linear filter 1306, is multiplied by an amplification factor v and subtracted as v×f3 from the sum signal f1+f2. The resulting signal s1 corresponds, in the case of three transducers, (f1+f2)−(v×f3).

The amplification factor v, to which direction the useful direction may lie, (e.g., the spatial direction) may be limited by the directional characteristic of the total synthesized signal. In some applications, the directions may be restricted (in other applications, unrestricted) and may depend on the number of gradient transducers within an arrangement. In a three transducers arrangement, 6 useful sound directions may be obtained, which are shown in FIG. 15. For example, if factor v is very small, the effect of the third transducer 330 on the overall signal is limited and the sum signal f1+f2 dominate over signal v×f3. If the amplification factor v is negative and large, the individual signal v×f3 dominates over the sum signal f1+f2 of the two other transducers 100, 120, and the useful sound direction or the direction in which the synthesized overall signal directs its sensitivity is therefore rotated by about 180° with reference to the former case. By variation of factor v, this arrangement permits a change in the sum signal, so that an arbitrary directional characteristic is generated in a desired direction.

Since all transducer signals are equivalent in this example, 6 possible directions to which bundling can be carried out, and which may be simultaneously processed by the processor. This may include the output signal of third transducer 330. For each direction in which bundling occurs, an intrinsic spectral subtraction block may be used. The signal processing acts occurring before the spectral subtraction block may be combined to the extent that only factor v need be different for two opposite directions. The preceding acts and branches remain the same for these two directions.

Through measurements of the individual transducers, the maximum level of a resulting figure-eight may be derived, (e.g., the level of the sum signal at precisely the angle at which the figure-eight signal is maximal). The data may be processed through a filter. In some systems, a control circuit is not needed. The rendering of filter coefficients may be based on a specification. The system improves the equality of the gradient transducers with reference to the rejection angle or the ratio of the omni and figure-eight signal. The resulting figure-eight of 3 possible difference signals (whose 0° frequency response was made substantially equivalent) are roughly the same.

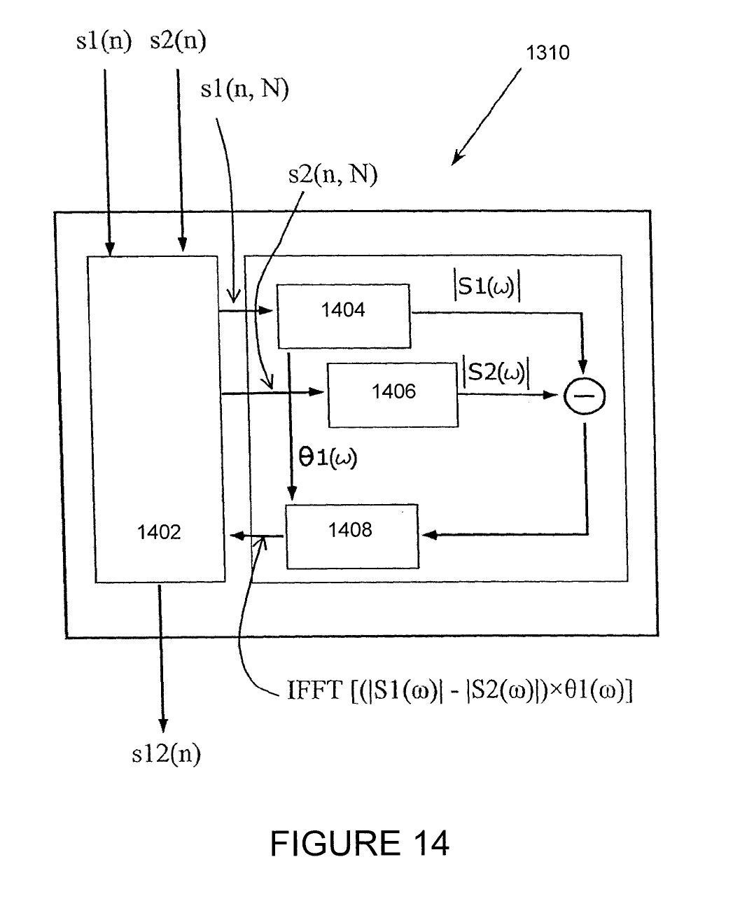

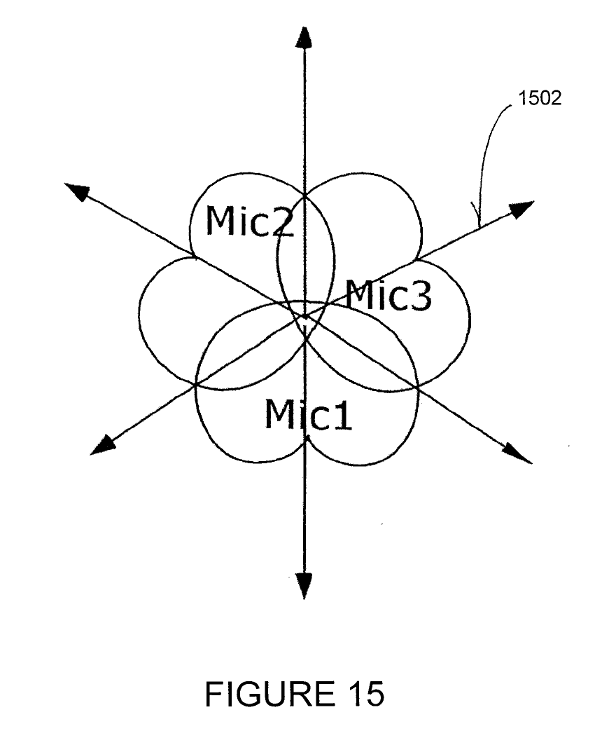

The spectral subtraction of the two intermediate signals s1 and s2 occurring in block 1310 is further described in FIG. 14. FIG. 14 shows exemplary components of a spectral subtraction 1310 in a digital domain. The signals are digitized through an A/D conversion that may occur before the spectral subtraction 1310. In the arrangement the filtering and signal combinations may occur in the analog domain. Two signals s1(n) and s2(n) received at block 1310 may be at the same point (or at least in the immediate vicinity). This ensures a coincident arrangement of transducers 100, 120, 330; s1(n) represents a signal that has the most useful signal portions. s2(n) represents the signal that includes more interference signals. s2(n) includes a zero position, in the viewing of the polar diagram, in the useful sound direction. n represents the sample index. s(n) corresponds to a signal in the time range.

In FIG. 14, unit 1402 generates individual blocks with a block length N=L(M−1) from the continuously arriving samples. L represents the number of new data samples in the corresponding block. The remainder (M−1) was found in the preceding block. This method is on the “overlap and save” method. “Digital Signal Processing” by John G. Proakis and Dimitris G. Manolakis (Prentice Hall), at 432, which is incorporated by reference, describes one example of method.

The N samples contained in a block are conveyed to the unit 1404 at the times at which M−1 samples have reached unit 1402 since the preceding block. The processing of unit 1404 occurs in a block-oriented manner. The signal s1(n, N) packed into blocks reaches unit 1404, the unit 1406 receives signal s2(n, N) packed into blocks in a similar format or protocol.

In units 1404, 1406, the end samples of signals s1 and s2 combined into a block are transformed by a FFT (fast Fourier transformation), for example, DFT (discrete Fourier transformation), into the desired frequency range. The signals S1(ω) and S2(ω) are broken down into magnitude and phase, so that the value signals |S1(ω)| and |S2(ω)| occur at the output of units 1404 and 1406. By spectral subtraction, the two value signals are subtracted and produce (|S1(ω)|−|S2(ω)|).

The resulting signal (|S1(ω)|−|S2(ω)|) is then transformed to the time domain. For this purpose, the phase Θ1(ω), which was separated in unit 1404 from signal S1(ω)=|S1(ω)|×Θ1(ω) and which, like the value signal |S1(ω)|, also has a length of N samples, is used during the time domain transformation. The time domain transformation occurs in unit 1408 through an IFFT device (inverse fast Fourier transformation), for example, IDFT (inverse discrete Fourier transformation) and is carried out based on the phase signal Θ1(ω) of S1(ω). The output signal of unit 1408 may be represented as IFFT [(|S1(ω)|−|S2(ω)|)×exp(Θ1(ω)]. The generated N samples of long digital time signal S12(n, N) is transmitted to processing unit 1402, where it is incorporated in the output data stream S12(n) according to an “overlap and save” method.

The parameters obtained in this method are block length N and rate (M−1)/fs [s] (with sampling frequency fs), with which the calculation or generation of a new block is initiated. In any individual sample, an entire calculation may be carried out, provided that the calculation unit is fast enough to carry out the entire calculation between two samples. In some conditions, about 50 ms has proven useful as the value for the block length and about 200 Hz as the repetition rate, in which the generation of a new block is initiated.

In these processes or systems the synthesized output signals s12(n) contain phase information from the special directions that point to the useful sound source, or are bundled on it. S1, whose phase is used, is the signal that has increasing useful signal portions, in contrast to s2. By this process, the useful signal is not distorted and therefore retains its original sound.

FIG. 15 shows the directional characteristics of the individual gradient transducers 100, 120, 330 and the directions from which a useful sound source may be received strongly bundled. If the direction designated 1502 is considered, from which a sound event is to be recorded in a bundled manner, the gradient transducers 100 and 120 may form the sum and subtraction signals. The directional characteristic of the third transducer is oriented toward direction 1502, so that maximal rejection occurs for this direction. Depending on the desired direction, the individual signals may be combined differently or changed. The principle may remain the same.

The functional method and effect may be apparent by the directional effect of the individual intermediate signals of 500 Hz and 2 kHz. FIG. 16 shows the synthesized directional characteristics of the individual combined signals M1, M2, M3 and the intermediate signals in which the amplitudes are normalized to the useful sound direction designated with about 0°, (e.g., all the polar curves and those during sound exposure from a 0° direction are normalized to about 0° dB). The output signal 1302 then has a directional characteristic bundled particularly strongly in one direction.

The subtraction signal f2−f1 forms a figure-eight, and the sum signal f2+f1 has an omni portion. During inclination of the main directions of the transducers or the projections of the main directions in the boundary, any angle between about 0° and about 180° may be implemented.

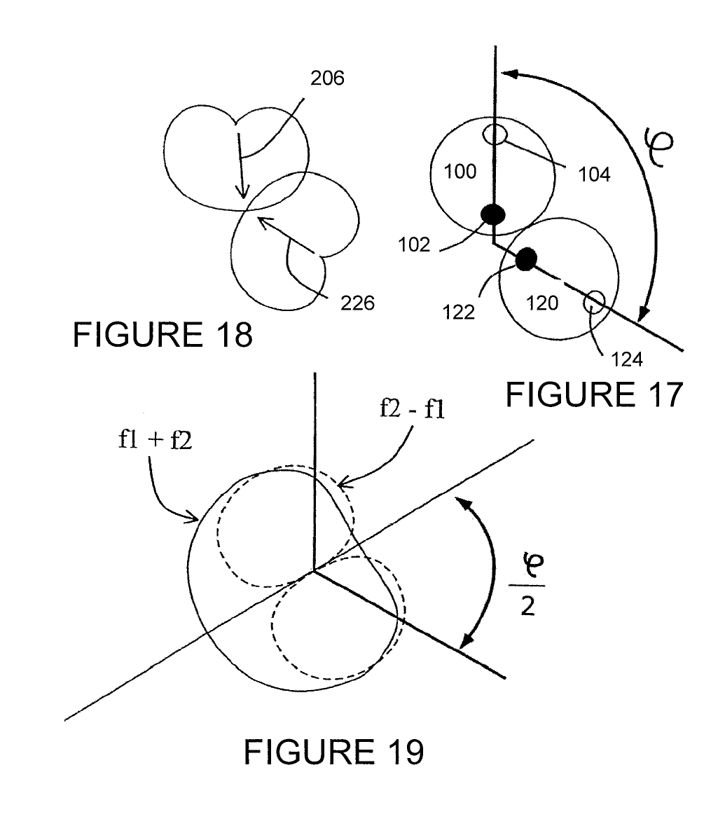

The orientation of the gradient transducers is not limited to the recited angles (e.g., may be different from 120°). When two gradient transducers are used an inclined relative to each other, a useful sound direction may be achieved, as shown in FIGS. 18 and 19. FIG. 17 corresponds substantially to FIG. 1. FIG. 19 represents—with reference to the directional characteristics 206, 226 of the two transducers 100, 120, shown in FIG. 18—the sum signal f1+f2 and the difference signal f2−f1. The broad cardioid (solid line) represents the sum signal f1+f2, and the figure-eight (dashed line) represents the difference signal. The angle φ denotes the slope of the main directions of the two transducers relative to each other.

In a microphone arrangement having three transducers, there may be six useful sound directions that can be implemented by corresponding signal processing (FIG. 5). More transducers are used in alternative systems. The signals may be weighted with similar amplification factors v and the sum signal may be modified.

Other alternate systems and methods may include combinations of some or all of the structure and functions described above or shown in one or more or each of the figures. These systems or methods are formed from any combination of structure and function described or illustrated within the figures. Some alternative systems or devices compliant with one or more of the transceiver protocols may communicate with one or more in-vehicle or out of vehicle receivers, devices or displays.

The methods and descriptions described may be programmed in one or more controllers, devices, processors (e.g., signal processors). The processors may comprise one or more central processing units that supervise the sequence of micro-operations that execute the instruction code and data coming from memory (e.g., computer memory) that generate, support, and/or complete a compression or signal modifications. The dedicated applications may support and define the functions of the special purpose processor or general purpose processor that is customized by instruction code (and in some applications may be resident to vehicles). In some systems, a front-end processor may perform the complementary tasks of gathering data for a processor or program to work with, and for making the data and results available to other processors, controllers, or devices.

The methods and descriptions may also be programmed between one or more signal processors or may be encoded in a signal bearing storage medium a computer-readable medium, or may comprise logic stored in a memory that may be accessible through an interface and is executable by one or more processors. Some signal-bearing storage medium or computer-readable medium comprise a memory that is unitary or separate from a device, programmed within a device, such as one or more integrated circuits, or retained in memory and/or processed by a controller or a computer. If the descriptions or methods are performed by software, the software or logic may reside in a memory resident to or interfaced to one or more processors or controllers that may support a tangible or visual communication interface, wireless communication interface, or a wireless system.

The memory may include an ordered listing of executable instructions for implementing logical functions. A logical function may be implemented through digital circuitry, through source code, or through analog circuitry. The software may be embodied in any computer-readable medium or signal-bearing medium, for use by, or in connection with, an instruction executable system, apparatus, and device, resident to system that may maintain persistent or non-persistent connections. Such a system may include a computer-based system, a processor-containing system, or another system that includes an input and output interface that may communicate with a publicly accessible distributed network through a wireless or tangible communication bus through a public and/or proprietary protocol.

A “computer-readable storage medium,” “machine-readable medium,” “propagated-signal” medium, and/or “signal-bearing medium” may comprise any medium that contains, stores, communicates, propagates, or transports software or data for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory, such as a Random Access Memory (RAM), a Read-Only Memory (ROM), an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A method of synthesizing a microphone signal from a coincident microphone arrangement, comprising
providing at least two pressure gradient transducers, whose directional characteristic comprises an omni portion and a figure-eight portion, each having a direction of maximum sensitivity in a main direction, the main directions of the at least two pressure gradient transducers are inclined relative to each other,
forming a difference signal and a summed signal from the output of the at least two pressure gradient transducers;
converting the difference signal and the summed signal into the frequency domain;
subtracting the magnitude of the frequency converted difference signal from the frequency converted summed signal independent of a respective phase;
designating a representative phase to the magnitude of the spectrally subtracted signal that corresponds to the phase of summed signal; and
converting the magnitude of the spectrally subtracted signal and the representative phase into the time domain.

2. A method of claim 1 where the frequency responses of the output of the at least two pressure gradient transducers and a third output of at least one other pressure gradient transducer are equalized to each other before forming the difference signal and the summed signal.

3. The method of claims 1 where the difference signal and the summed signal are filtered as a function of frequency, such that the spectral subtraction renders a signal having minimal energy.

4. The method of claims 1 where the difference signal or the summed signal is filtered as a function of frequency, such that the spectral subtraction renders a signal having minimal energy.

5. The method of claim 4 where the microphone arrangement comprises at least three pressure gradient transducers and the output signal of the third pressure gradient transducer is weighted, where the summed signal comprises a difference between the output signal of the third pressure transducer and the sum of outputs of the at least two pressure gradient transducers.

6. The method of claim 1 where the microphone arrangement comprises at least three pressure gradient transducers and the output signal of the third pressure gradient transducer is weighted, where the summed signal comprises a difference between the output signal of the third pressure transducer and the sum of outputs of the at least two pressure gradient transducers.

7. The method of claim 1 further comprising a combination of pressure gradient transducers in which the acts of forming the difference signal, converting the difference signal, subtracting the magnitude, and the act of designating a representative phase occurs simultaneously between the combinations of pressure gradient transducers.

8. A microphone arrangement, comprising:
at least two pressure gradient transducers, each having a diaphragm and a first sound inlet opening that leads to the front of the diaphragm, and a second sound inlet opening that leads to the back of the diaphragm,
the at least two pressure gradient transducers having a directional characteristic that comprises an omni portion and a figure-eight portion and have a direction of maximum sensitivity in a main direction;
a boundary at which the at least two pressure gradient transducers are arranged facilitates projections of the main directions of the at least two pressure gradient transducers that are inclined relative to each other at the boundary; and
acoustic centers of the at least two pressure gradient transducers lie within an imaginary sphere having a radius corresponding to double the largest dimension of the diaphragm of one of the at least two pressure gradient transducers.

9. The microphone arrangement according to claim 9 where the acoustic centers of the at least two pressure gradient transducers lie within an imaginary sphere whose radius corresponds to the largest dimension of the diaphragms between the at least two pressure gradient transducers.

10. The microphone arrangement according to claim 9 where an angle of inclination between two projections of the main directions at the boundary lies between about 20° and about 160°.

12. The microphone arrangement according to claim 9 where an angle of inclination between two projections of the main directions at the boundary lies between about 30° and about 150°.

13. The microphone arrangement according to claim 8 where an angle of inclination between two projections of the main directions at the boundary lies between about 20° and about 160°.

14. The microphone arrangement according to claim 8 where an angle of inclination between two projections of the main directions at the boundary lies between about 30° and about 150°.

15. The microphone arrangement according to claims 8 where angle of inclination between individual main directions of the at least two pressure gradient transducers and the boundary lies between about 0° and about 60°.

16. The microphone arrangement of claim 1 the at least two pressure gradient transducers are embedded in the boundary.

17. The microphone arrangement according to on of claim 8 where each of the first sound inlet opening and the second sound inlet opening of the at least two pressure gradient transducers are arranged on a common side of a housing.

18. The microphone arrangement according to claim 17 where the at least two pressure gradient transducers further comprise front surfaces that are substantially flush with the boundary.

19. The microphone arrangement of claim 8 where the first sound inlet opening of each of the at least two pressure gradient transducers is arranged on the front of the transducer housing and the second sound inlet opening of each of the at least two pressure gradient transducers is arranged on the back of the transducer housing.

20. The microphone arrangement of claim 8 where the at least two pressure gradient transducers are arranged on a common transducer housing.

21. The microphone arrangement of claim 8 further comprising at least a third pressure gradient transducers, where the projections in the main directions of each of the pressure gradient transducers enclose an angle with each other in the boundary lying between about 110° and about 130°.

22. The microphone arrangement of claim 21 where the projections of the main directions of each of the pressure gradient transducers enclose an angle of substantially 120° with each other at the boundary.

23. A microphone arrangement, comprising:
at least two pressure gradient transducers having a diaphragm, each pressure gradient transducer having a first sound inlet opening that leads to the front of the diaphragm, and a second sound inlet opening that leads to the back of the diaphragm, and having a directional characteristic comprising an omni portion and a figure-eight portion;
where the first and second sound inlet openings in the pressure gradient transducers are arranged on a common side, and the fronts of the pressure gradient transducers lie substantially in a plane,
a plurality of projections of the at least two pressure gradient transducers that lie in the main directions are inclined with the plane relative to each other, and
a plurality of acoustic centers of the at least two pressure gradient transducers lie within an imaginary sphere having a radius corresponding to about double the largest dimension of one of the diaphragms of the at least two pressure gradient transducer.

24. The microphone arrangement of claim 23 where the plurality of acoustic centers of the pressure gradient transducers lie within an imaginary sphere having a radius corresponding to the largest dimension of one of the diaphragms of the at least two pressure gradient transducers.
